(19) United States
(12) Patent Application Publication
(10) Pub. No.: US 2026/0355924 A1
(43) Pub. Date: Nov. 12, 2026

(54) Powered Multi-Tool

(71) Applicant: Milwaukee Electric Tool Corporation, Brookfield, WI (US)

(72) Inventors: Ryan M. McManus, Menomonee Falls, WI (US); David A. Bierdeman, New Berlin, WI (US)

(21) Appl. No.: 19/631,190

(22) Filed: Mar. 27, 2026

Related U.S. Application Data
(60) Provisional application No. 63/802,327, filed on May 8, 2025.

(51) Int. Cl. B25F 5/00; B27B 19/00

(52) U.S. Cl. CPC B25F 5/006; B27B 19/006

(57) ABSTRACT

Various embodiments of a powered multi-tool configured to attenuate forces are provided. The powered multi-tool includes a housing with a motor connected to a gearbox and a power source supported within the housing. The motor transmits motion to the drive mechanism to move a spindle that is engaged with an output element such as a blade. In various embodiments, a compliant mechanism configured to attenuate the transfer of forces within the housing is positioned between the motor and the power source. In specific embodiments, a counterweight is supported at a distal end of the spindle to attenuate vibrations of the multi-tool. In specific embodiments, the powered multi-tool includes a cam with a first cam surface and a second cam surface.

### CROSS-REFERENCE TO RELATED PATENT APPLICATION

The present application claims the benefit of and priority to U.S. Provisional Application No. 63/802,327, filed on May 8, 2025, which is incorporated herein by reference in its entirety.

### BACKGROUND OF THE INVENTION

The present invention relates generally to the field of powered multi-tools. The present invention relates specifically to a powered or hand held multi-tool (e.g., oscillating/reciprocating tool) with a counterweight and/or compliant mechanism configured to attenuate forces (e.g., vibrations).

### SUMMARY OF THE INVENTION

An embodiment of the invention relate to a powered multi-tool. The tool includes a housing with a first end and a second end opposite the first end, a head, and a motor. The head is positioned at the first end of the housing. The motor and a drive mechanism are supported at least partially within the housing. The drive mechanism includes an output shaft configured to move in a rotational and oscillating manner and defining an output axis. The tool further includes a power source, an elastic component, and a counterweight. The power source is positioned at the second end of the housing and is configured to supply power to the motor. The elastic component includes one or more ribs extending between the motor and the power source. The counterweight is positioned along an axis defined by the motor, between the elastic component and the motor.

Another embodiment of the invention relate to a powered multi-tool. The tool includes a housing, a head, and a motor. The head is positioned at a first end of the housing. The motor and a drive mechanism are supported at least partially within the housing. The drive mechanism includes an output shaft configured to move in a rotational and oscillating manner and defining an output axis. The tool further includes a power source, an elastic component, and a mass damper. The power source is positioned at least partially within the housing and is configured to supply power to the motor. The elastic component includes at least one rib extending between the motor and the power source. The mass damper is supported at a distal end of the output shaft and positioned between the accessory and the housing.

Another embodiment of the invention relate to a powered multi-tool. The tool includes a housing, a head, and a motor. The head is positioned at a first end of the housing. The motor and a drive mechanism are supported at least partially within the housing. The drive mechanism includes an output shaft positioned at the head and configured to move in a rotational and oscillating manner and defining an output axis. The tool further includes a clamping assembly that supports the output shaft at least partially within the housing. The clamping assembly includes a cap, a cam rotatably engaged with the cap. The cam includes a first cam surface and a second cam surface. When the first cam surface is engaged with the cap the output shaft is securely coupled to the housing. When the second cam surface is engaged with the cap, the output shaft is removable from the housing. The tool includes a power source, an elastic component, and a mass damper. The power source is positioned at least partially within the housing and is configured to supply power to the motor. The elastic component includes at least one rib extending between the motor and the power source. The mass damper is supported at a distal end of the output shaft and positioned between the accessory and the housing.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 shows a perspective view of a multi-tool, according to an exemplary embodiment.

FIG. 2 is a partially exploded view of the multi-tool of FIG. 1 with the handle removed, according to an exemplary embodiment.

FIG. 3 is a partially exploded view of the multi-tool of FIG. 1 from below, with the handle removed, according to an exemplary embodiment.

FIG. 4 is a perspective view of the multi-tool with the handle removed, according to an exemplary embodiment.

FIG. 5 is a view of the multi-tool from above, with the handle removed, according to an exemplary embodiment.

FIG. 6 is a cross-sectional view of the handle taken along line 6-6 in FIG. 2, according to an exemplary embodiment.

FIG. 7 is a cross-sectional view of the handle taken along line 7-7 in FIG. 2, according to an exemplary embodiment.

FIG. 8 is a cross-sectional view of the multi-tool taken along line 8-8 in FIG. 2, according to an exemplary embodiment.

FIG. 9 is a cross-sectional view of the multi-tool with the handle removed, according to an exemplary embodiment.

FIG. 10 is a cross-sectional view of the multi-tool taken along line 10-10 in FIG. 2, according to an exemplary embodiment.

FIG. 11 is detailed views of a compliant mechanism and clamping assembly of the multi-tool, according to an exemplary embodiment.

FIG. 12 is a detailed view of the compliant mechanism and a counterweight, according to an exemplary embodiment.

FIG. 13 is detailed views of the compliant mechanism and a gearbox, according to an exemplary embodiment.

FIGS. 14-16 are views of the motor and gearbox housing showing rotation and translation, according to exemplary embodiments.

FIG. 17 is a perspective view of the multi-tool with the housing and battery receptable removed, according to an exemplary embodiment.

FIG. 18 is a perspective view of a mass damper, according to an exemplary embodiment.

FIG. 19 is a view from below of the mass damper of FIG. 18 engaged with the output element of the multi-tool, according to an exemplary embodiment.

FIG. 20 is a portion of the clamping assembly, according to an exemplary embodiment.

FIG. 21 is cross-sectional view of the clamping assembly, according to an exemplary embodiment.

FIG. 22 is a perspective view of a dual cam of the clamping assembly, according to an exemplary embodiment.

FIG. 23 is a cross-sectional view of the clamping assembly, according to an exemplary embodiment.

FIG. 24 is cross-sectional views showing the engagement of the dual cam of the clamping assembly, according to an exemplary embodiment.

FIG. 25 is cross-sectional views showing reclamping and engagement of the dual cam, according to an exemplary embodiment.

FIGS. 26A-C show the clamping assembly in locked and unlocked positions, according to an exemplary embodiment.

### DETAILED DESCRIPTION

Referring generally to the figures, various embodiments of a powered multi-tool shown as a hand held oscillating/reciprocating multi-tool are provided.

In various embodiments, the multi-tool includes a compliant mechanism configured to attenuate the transfer of forces, such as vibrations between portions of the multi-tool. For example, between a first portion of the tool including the motor and/or gearbox and a second portion of the tool that includes a controller and/or battery. In such embodiments, the gearbox is spaced from the handle (e.g., no direct contact).

In a specific embodiment, the compliant mechanism includes an elastic component with one or more ribs extending between the motor and/or gearbox and a controller and/or battery. In a specific embodiment, the compliant mechanism is coupled to a counterweight and extends from the counterweight to a controller and/or battery. In such an embodiment, the counterweight is positioned between the compliant mechanism and the motor and/or gearbox. In a specific embodiment, the counterweight connects directly to a back plate of the motor.

In various embodiment, the multi-tool includes a counterweight or mass damper engaged with a spindle of the multi-tool to attenuate forces, such as vibrations during operation of the tool. In a specific embodiment, the counterweight includes a generally arcuate segment that extends further radially outward from a central axis of the spindle and is oriented (in one configuration) opposite to the working attachment (e.g., a blade).

In various embodiments, the multi-tool includes a blade clamping mechanism with a dual action cam. In a specific embodiment, the cam has a first profile or surface and a second cam profile or surface different than the first cam profile. As the cam is actuated, the blade clamping mechanism is moveable between a locked or clamped position and an unlocked or unclamped position.

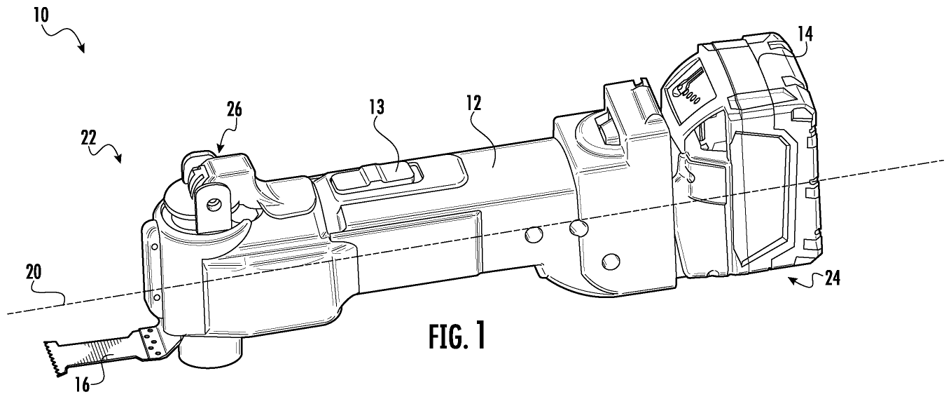

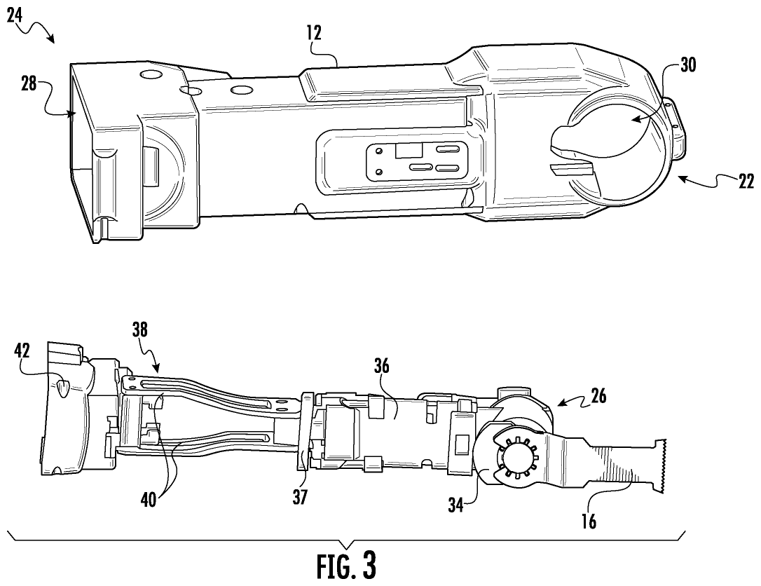

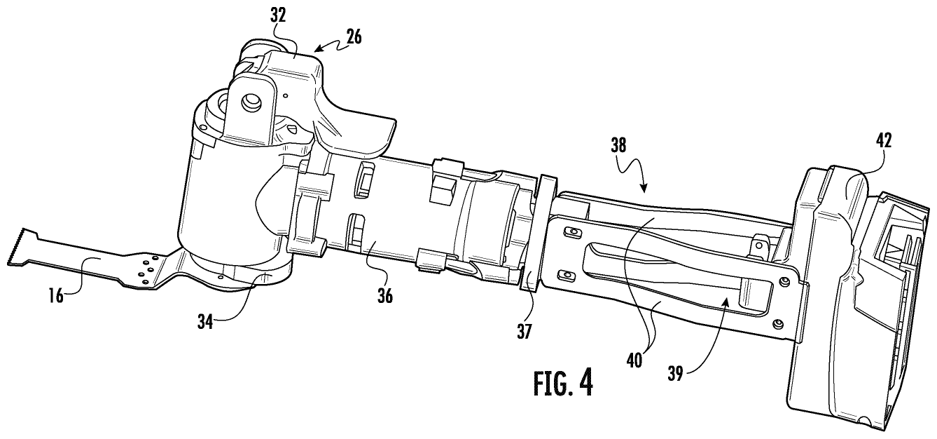

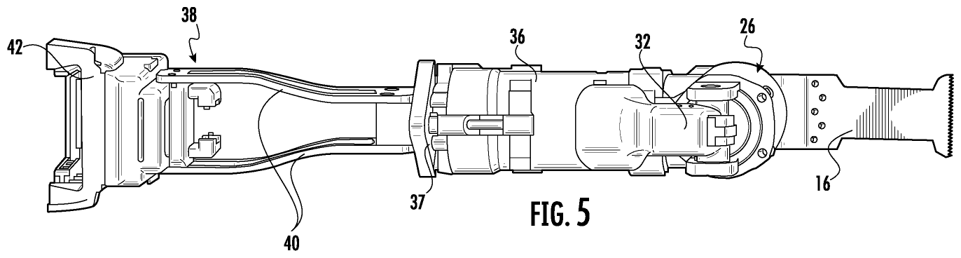

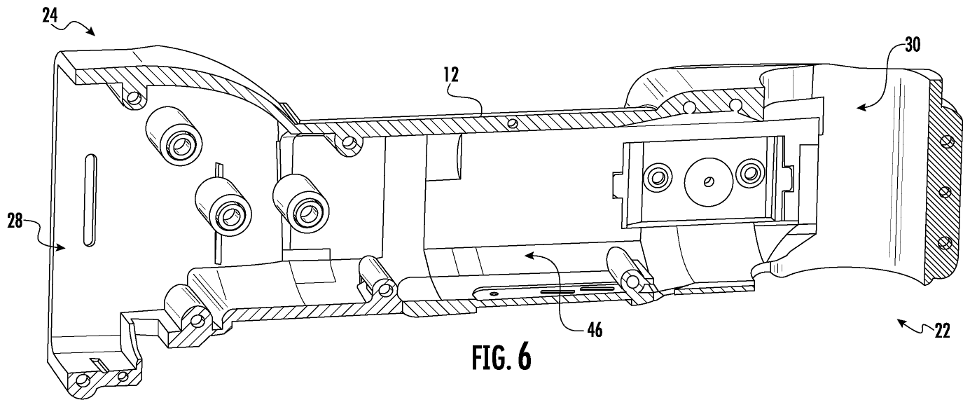

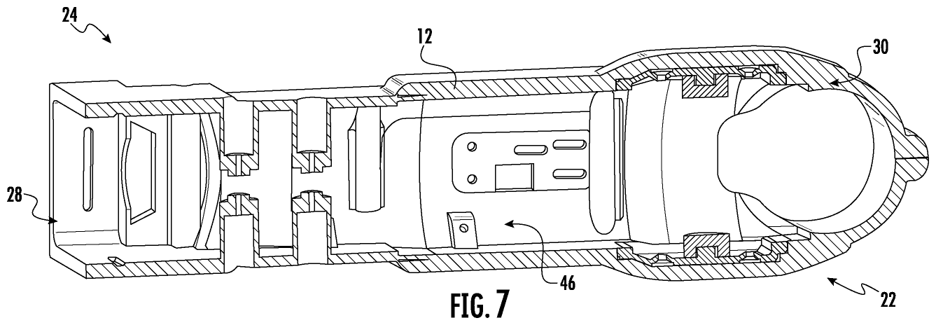

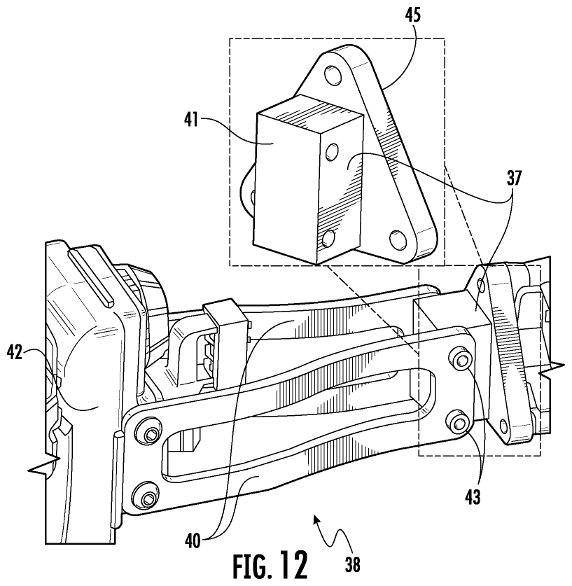

Referring to FIGS. 1-7, details of a powered tool, shown as an oscillating/reciprocating multi-tool 10 are shown according to an exemplary embodiment. Multi-tool 10 includes a housing 12, a motor 48 supported within a motor and/or gearbox housing 36, a drive mechanism including an output shaft or spindle 54 (see e.g., FIG. 11) engaged with an output element or accessory, shown as a cutting blade 16. In various specific embodiments, the drive mechanism are the eccentric shaft holding a bearing that oscillates the shaft via a yoke. Mutli-tool 10 further includes a clamping assembly 26 and a power source, shown as a battery pack 14 for powering motor 48.

In various embodiments, housing 12 incudes a head, shown as a cutting head 22 and a handle 24 extending from the cutting head 22 along a longitudinal axis 20. Housing 12 includes a battery support or receptacle 42 positioned at an end of handle 24 opposite cutting head 22.

The cutting head 22 is configured to support the output element 16, the clamping assembly 26, and the motor 48. The handle 24 is configured to be grasped by a user during operation of the multi-tool 10. Alternatively, a user may grasp the cutting head 22 during operation of multi-tool 10. In various embodiments, the housing 12 is formed from one or more components that enclose the drive mechanism and motor 48 at least partially within an internal cavity 46 of housing 12. In various embodiments, housing 12 includes a cavity 30 within cutting head 22 configured to support at least a portion of the drive mechanism.

An actuator 13 is positioned on housing 12 adjacent to cutting head 22. Actuator 13 switches motor 48 between an on and an off modes. In various specific embodiments, actuator 13 switches motor 48 between different speeds. In a specific embodiment, multi-tool 10 includes an automatic mode that determines speed based on the current draw. In a specific embodiment, actuator 13 is a slidable with respect to housing 12 in a direction generally parallel to longitudinal axis 20. In other embodiments, actuator 13 may have other configurations (e.g., trigger-style actuator, lever, paddle, rotatable, depressible, etc.).

The battery receptacle 42 is configured to support the battery pack 14 on an end 28 of housing 12. The battery pack 14 is configured to connect to the battery receptacle 42 and is electrically coupled to the motor 48. During operation of the multi-tool 10, the battery pack 14 supplies power to the motor 48.

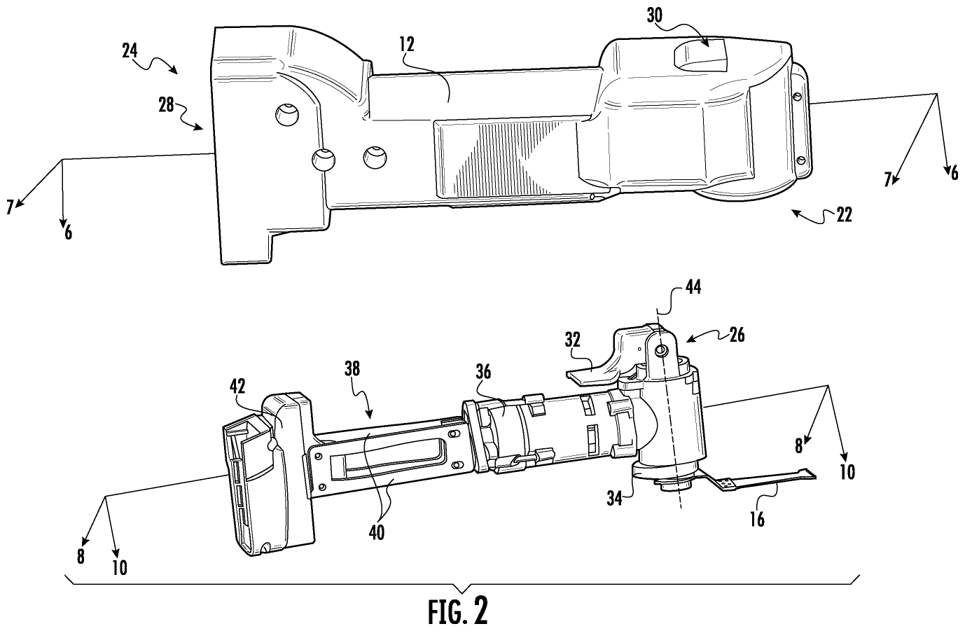

With references to FIGS. 2-5, in various embodiments, multi-tool 10 includes a compliant mechanism 38. As will be generally understood, compliant mechanism 38 provides attenuation of forces, such as vibrations between portions of the multi-tool 10 during operation. For example, in various embodiments, compliant mechanism 38 attenuates forces between a first portion of housing 12 such as head 22 and end 28 of housing where battery pack 44 is positioned.

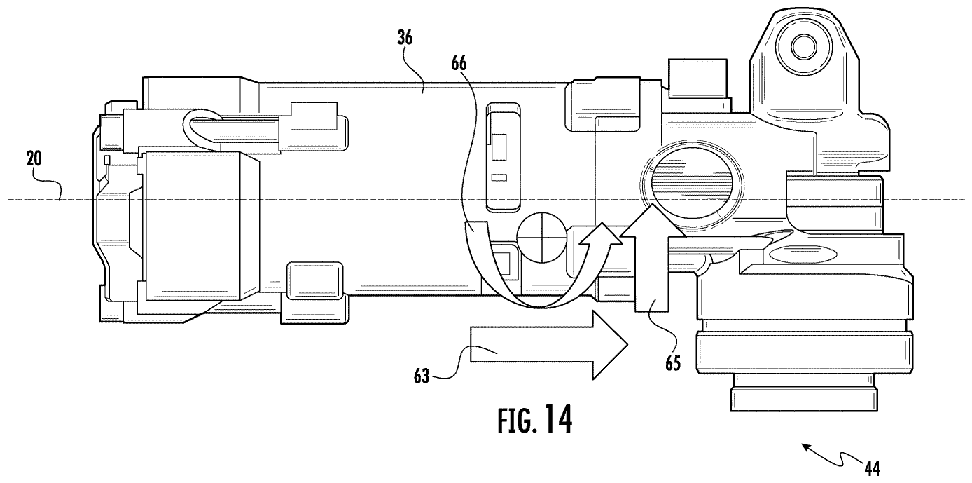

In specific embodiments, compliant mechanism 38 includes an elastic component with one or more ribs 40 extending between the motor 48 and/or gearbox 49 (see, e.g., FIG. 13) and a controller and/or battery pack 14.

In a specific embodiment, the compliant mechanism 38 is coupled to a counterweight 37 and extends from the counterweight 37 to a controller, battery receptacle 42 and/or battery pack 14. In such an embodiment, the counterweight 37 is positioned between the compliant mechanism 38 and the motor 48 and/or gearbox housing 36. In a specific embodiment, the counterweight 37 connects directly to a back plate of the motor 48.

In various embodiments, the counterweight is positioned along longitudinal axis 20 and/or the motor 48 axis. In various embodiments, longitudinal axis 20 is the same as a motor axis. In a specific embodiment, the counterweight 37 is positioned between a backplate of motor 48 and compliant mechanism 38 along longitudinal axis 20.

In various embodiments, additional weight is added to the motor gearbox such that motor 48 acts as a counterweight. In a specific embodiment, the weighted gearbox is positioned between the back plate and counterweight 37 which is between the back plate and compliant mechanism 38. In various embodiments, a plastic housing is coupled to motor 48 and/or the backplate of motor 48. In such embodiments, the counterweight 37 is positioned between the plastic housing and the compliant mechanism 38. In various embodiments, the complaint mechanism 38 is also coupled to the plastic housing. In various embodiments, counterweight 37 is coupled to housing 12 along motor axis 20. In a specific embodiment, counterweight 37 is positioned at the front gearcase.

In a specific embodiment, compliant mechanism 38 includes a first pair of ribs 40 and a second pair of ribs 40 positioned on opposite sides of longitudinal axis 20 of multi-tool 10. In various embodiments, a space or gap 39 is defined between respective ribs 40 of the pair of ribs 40. In various embodiments, ribs 40 include a curved portion. In specific embodiments, the curved portion extends outward (i.e., toward housing 12). In such embodiments, a distance from longitudinal axis 20 of multi-tool 10 to ribs 40 varies along a length of the ribs 40.

In various specific embodiments, a distance or width between opposing ribs 40 (view from above in FIG. 13) is a first distance near counterweight 37 and a second distance near battery receptacle. In specific embodiments, the first distance is less than the second distance. In other words, opposing sets of ribs 40 are spaced apart different amounts. Applicant has found such spacing increases stiffness to promote yaw freedom.

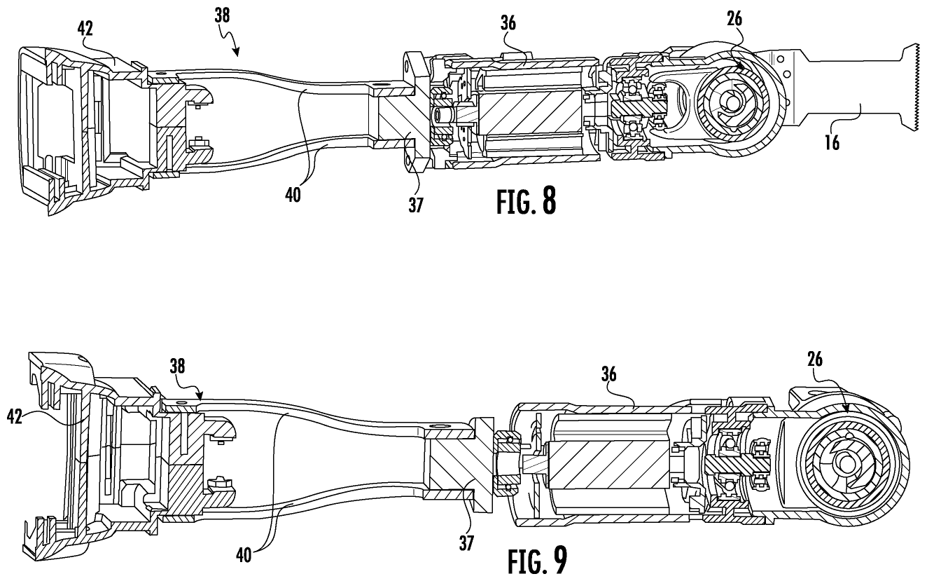

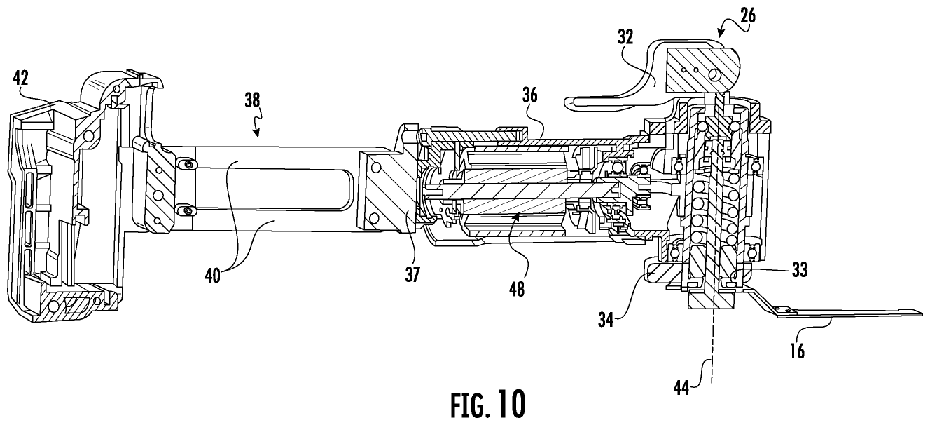

With reference to FIGS. 8-11, the output element 16 is coupled to an output shaft or spindle 54 of the drive mechanism. In various embodiments, output element 16 is located at an opposite end of the housing from battery receptacle 42. In various embodiments, the spindle 54 extends at least partially out of housing 12. In a specific embodiment, a distal end of spindle 54 is positioned outside of housing 12 and/or cavity 30. In specific embodiments, bearings are in place on opposing sides of longitudinal axis. In specific embodiments, the bearings are 6 mm inner diameter and 19 mm outer diameter ball bearings.

In the illustrated embodiment, the spindle 54 defines an output axis 44 substantially perpendicular to longitudinal axis 20. When energized, the motor 48 drives the drive mechanism to oscillate the spindle 54 and the output element 16 about the output axis 44. In various embodiments, the output element 16 may be a cutting blade or a different type of blade such as a scraper blade, a circular blade, a semi-circular blade, etc., or a different type of element such as a sanding pad, a grinding element, etc.

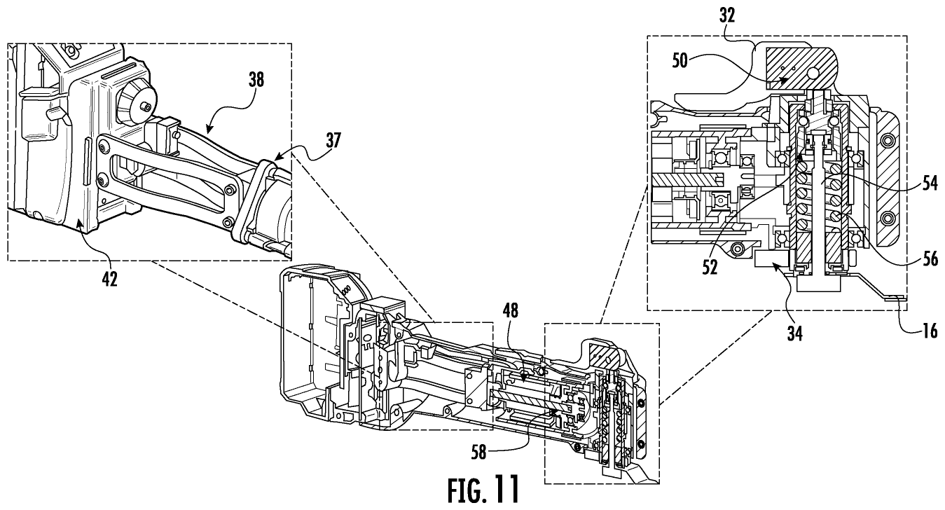

Referring to FIGS. 10-11, the clamping assembly 26 is configured to clamp the output element 16 to the spindle 54. In various embodiments, clamping assembly 26 includes a lever 32 having a cam. As will be discussed in greater detail, in various specific embodiments, the cam is a dual action cam. In various embodiments, the clamping assembly 26 includes the spindle 54 having an accessory holder 33 disposed at a distal end. The accessory holder 33 is configured to receive the output element 16, and the clamping assembly 26 clamps the output element 16 to the accessory holder 33. The spindle 54 extends through an opening of the cutting head 22 of the housing 12. In various embodiments, the accessory holder 33 at the end of spindle 54 is external to the cutting head 22 of the housing 12.

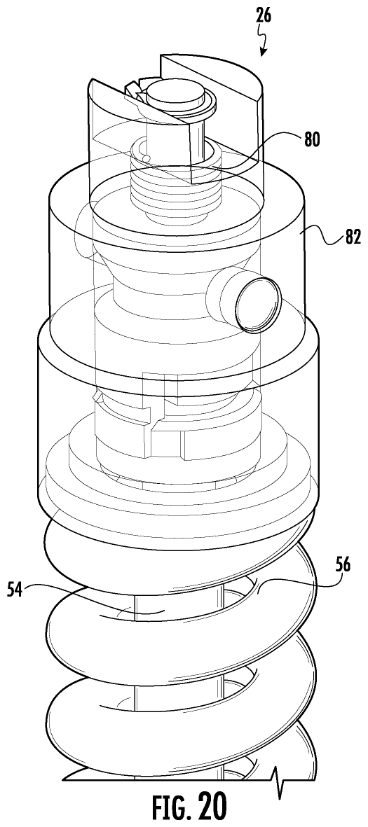

In various embodiment, the multi-tool 10 includes a counterweight or mass damper 34 engaged with a spindle 54 of the multi-tool 10 to attenuate forces, such as vibrations during operation of the multi-tool 10. As will be discussed in greater detail below, in a specific embodiment, the counterweight 34 includes a generally arcuate segment 74 that extends further radially outward from a central axis 44 of the spindle 54 and is oriented (in one configuration) opposite to the working attachment (e.g., a blade) (see, e.g., FIG. 19). In various embodiments, counterweight 34 is engaged with the distal end of spindle 54. In various embodiments, counterweight 34 is positioned within the housing of multi-tool 10 (i.e., under the yoke).

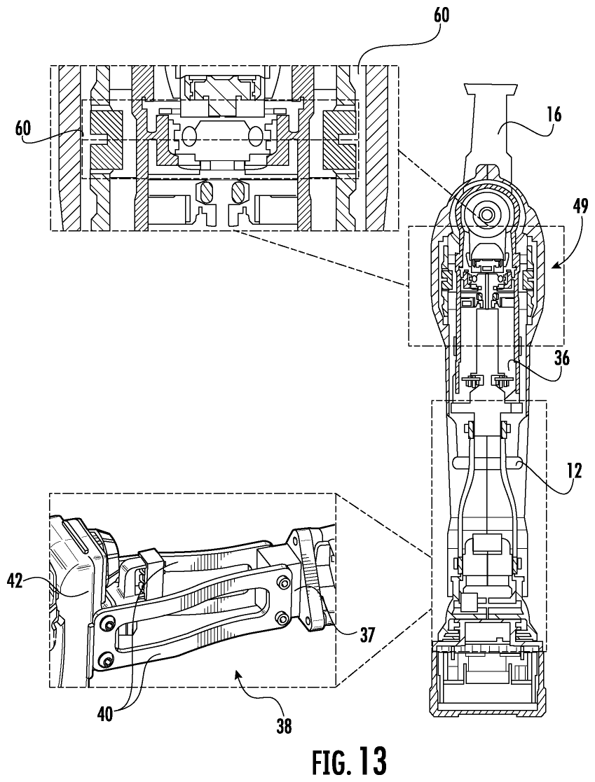

Referring to FIG. 12, a detailed view of compliant mechanism 38 and counterweight 37 are shown according to an exemplary embodiment. In various embodiments, counterweight 37 is positioned between ends of two pairs of ribs 40. In specific embodiments, a first end 41 of counterweight 37 is fixed between the ends of pairs of ribs 40 by one or more fasteners 43. In such embodiments, a second end 45 of counterweight 37 is coupled to the motor 48 and/or gearbox housing 36. In specific embodiments, the second end 45 has a cross-sectional shape of a triangle with rounded corners. In other embodiments, the geometry of the first and second ends of counterweight 37 may be different. In a specific embodiment, the counterweight 37 connects directly to a backplate of motor 48 and has a weight of about 130 grams. In a specific embodiment, the backplate of motor 48 itself acts as the counterweight.

Referring to FIG. 13, a detailed view of the gearbox 49 of multi-tool 10 is shown according to an exemplary embodiment. In various embodiments, the gearbox 49 is spaced from the housing 12 (e.g., no direct contact). As will be understood, such a position reduces the risk of transmission of vibrations. In other embodiments, the gearbox 49 is connected to the housing 12 at low vibration areas of the gearbox. In various embodiments, foam 60 is positioned on opposite sides of a center of mass of the gearbox 49. In various embodiments, foam 60 is positioned on opposite sides of gearbox 49 and spaced from housing 12. Applicant believes this positioning minimizes the rotational acceleration that will transfer through the foam 60. In a specific embodiment, foam 60 has a centered anchor point. In a specific embodiment, foam 60 has a rear biased anchor point.

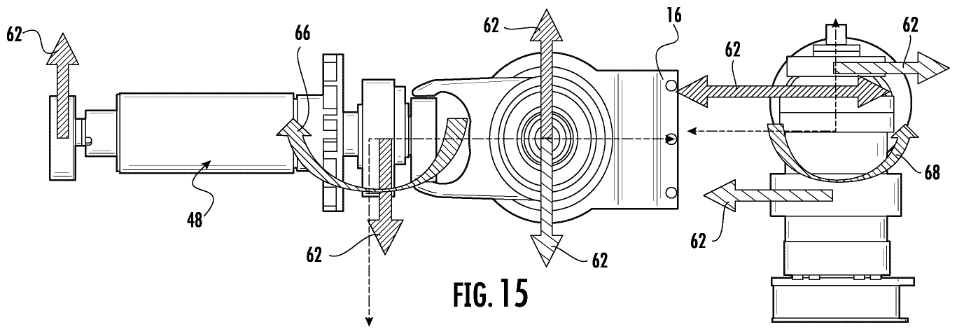

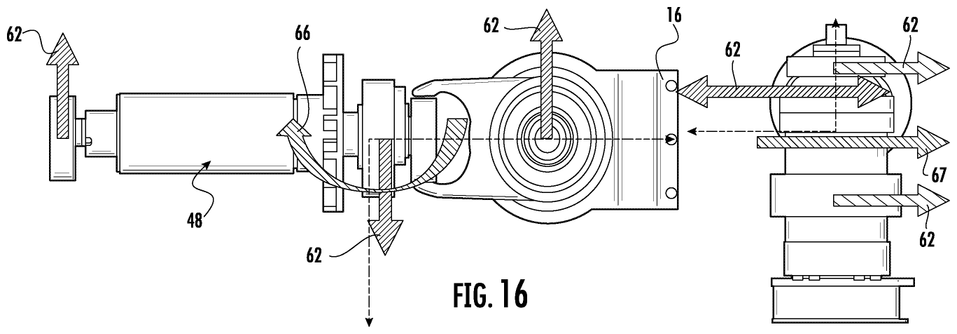

Referring to FIGS. 14-16, details of the gearbox 49 and the motion caused by the motor 48 and/or gear box are shown according to an exemplary embodiment. As previously discussed, counterweight 37 is positioned to address the rotation and translation of multi-tool 10. As shown in FIG. 15, the bearing reaction forces 62 create rotation. With the yaw 66 and roll 68 shown. When there is no counterweight used with multi-tool 10, forces 62 oppose each other due to the blade force.

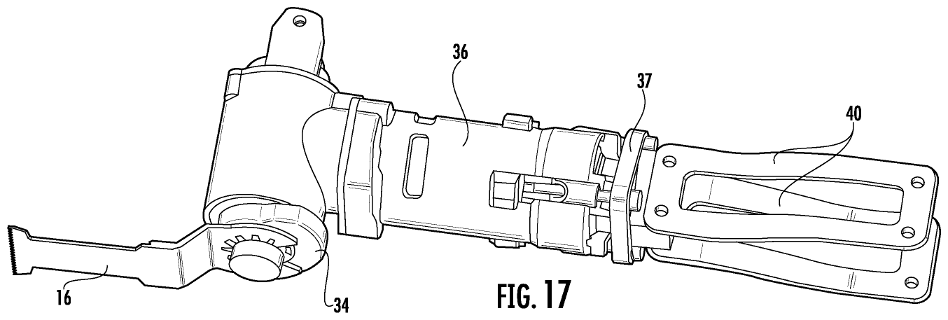

As shown in in FIG. 16, when counterweight 37 is added to multi-tool 10, forces 62 are flipped on the bottom bearing of the front gearbox. Applicant has found this not only greatly reduces roll 68, but also changes it to yaw 66 and translation 67. Applicant has found the compliant mechanism 38 and counterweight 37 are effective at reducing the rotation (i.e., from counterweight) and transmission between bodies (from compliant mechanism) for yaw specific rotation.

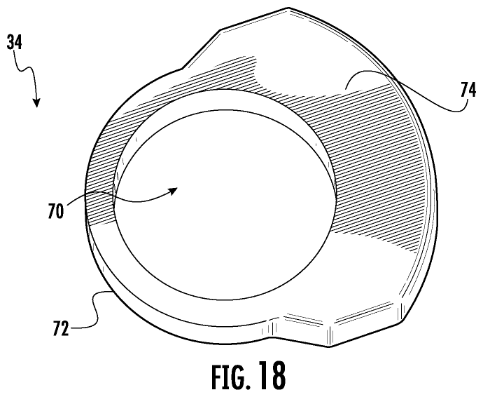

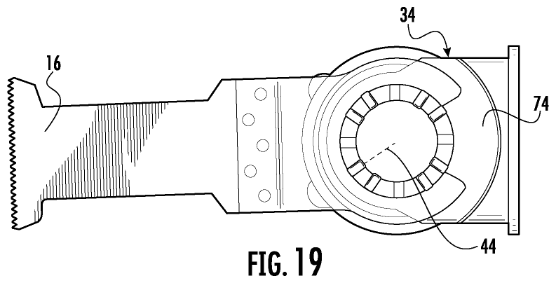

Referring to FIGS. 17-19, details of the counterweight 34 are shown according to an exemplary embodiment. In various embodiments, counterweight 34 includes a bore 70. When multi-tool 10 is assembled, output axis 44 of spindle 54 is centered within bore 70. In various embodiments, counterweight 34 includes a first segment 72 positioned at least partially on a first side of bore 70 and a second segment 74 positioned at least partially on a second side of bore 70. Second segment 74 is a generally arcuate segment that extends further radially outward from the central output axis 44 of spindle 54. In other words, a radial dimension of the second segment 74 is greater than a radial dimension of first segment 72. In specific embodiments, second segment 74 is oriented opposite of the output element 16 or cutting end in the illustrated embodiment.

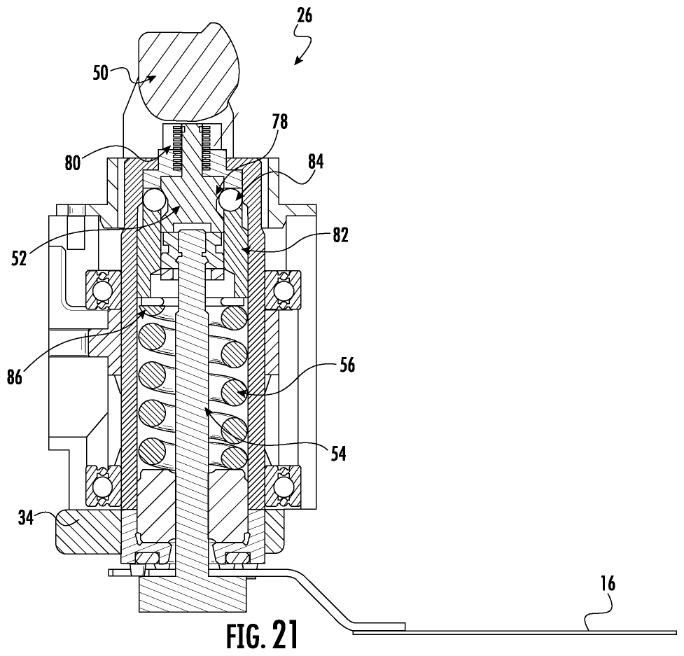

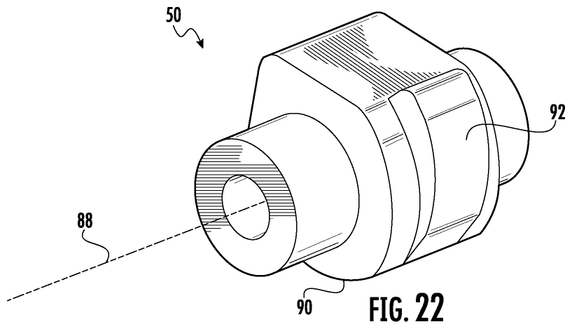

Referring to FIGS. 20-26B, details of the clamping assembly 26 are shown according to an exemplary embodiment. As shown in FIGS. 20-21, clamping assembly includes a cap 82 with an actuator return spring 80 positioned within the cap 82. Dual action cam 50 engages cap 82 as cam 50 rotates. A clamp actuator 52 is positioned at least partially within cap 82. In various embodiments, clamp actuator 52 includes a groove 78 positioned on a side of the clamp actuator 52. In various embodiments, a ball 84 is positioned at least partially within groove 78 and between clamp actuator 52 and cap 82.

In specific embodiments, clamp actuator 52 includes a pair of grooves 78 positioned on opposite sides. In such embodiments, clamping assembly 26 includes a pair of balls 84 positioned in each of the respective grooves 78. Balls 84 act as load transfer balls.

A biasing component, shown as spring 56 is positioned below cap 82. In various embodiments, a washer 86 is positioned between spring 56 and cap 82. Washer 86 acts as a load transfer washer. In specific embodiments, spindle 54 extends through a center of spring 56.

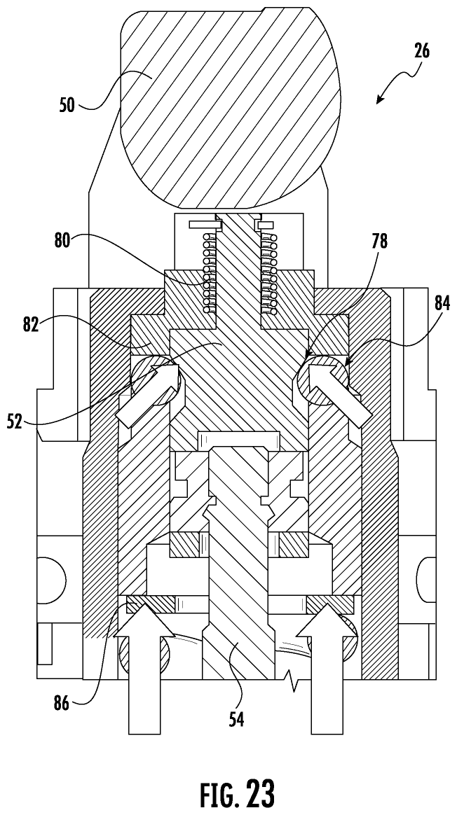

Referring to FIG. 22, a perspective view of dual action cam 50 is shown according to an exemplary embodiment. Axis of rotation 88 defines the axis of rotation of dual action cam 50. Dual action cam 50 includes a first cam surface 90 and a second cam surface 92. First cam surface 90 has a different profile than second cam surface 92. Second cam surface 92 has a greater radial extension from axis of rotation 88 than first cam surface 90.

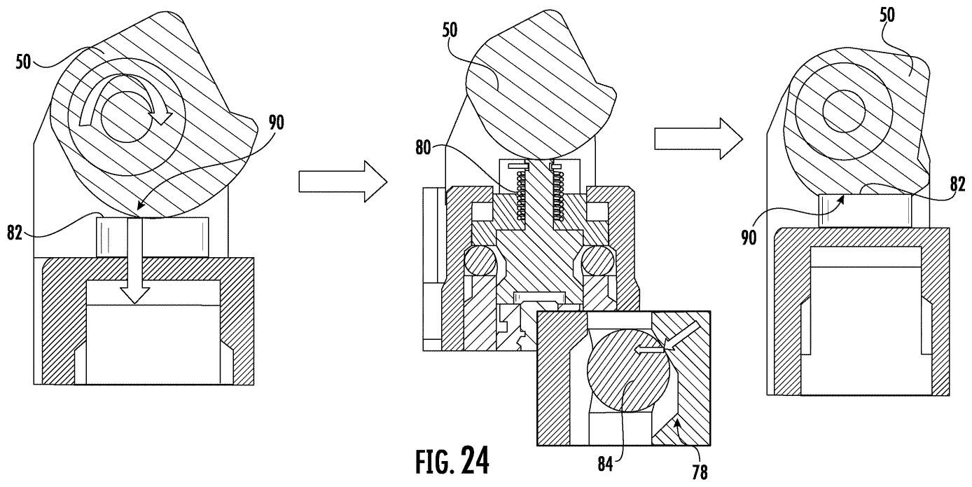

Referring to FIG. 23, details of clamping assembly 26 with the cam actuator 52 in a top position are shown according to an exemplary embodiment. When the clamping assembly 26 is in the top position, the ball(s) 84 do not have space to move out of the groove(s) 78 of the clamp actuator 52. As such, the actuator return spring 80 is preloaded.

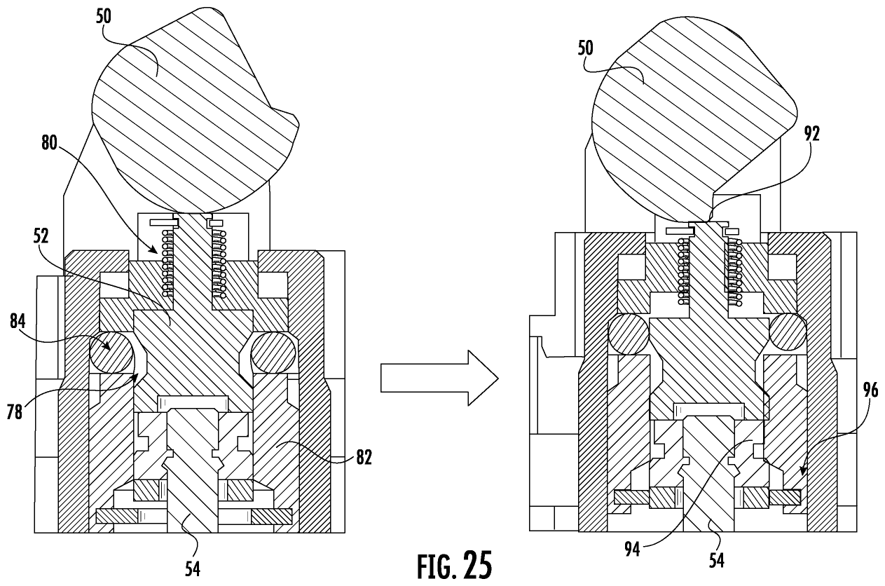

Referring to FIG. 24, cross-sectional views showing engagement of first cam surface 90 are shown according to an exemplary embodiment. As shown in the first cross-sectional view of clamping assembly 26, first cam surface 90 of dual cam actuator 50 interfaces against cap 82 and provides a force (see, e.g., arrow) downward (i.e., in direction toward cap 82). As shown, the first cam surface 90 moves cap 82 down a distance. In specific embodiments, the distance is about 2.25 mm.

The force allows the ball(s) 84 out of the groove(s) 78 of clamp actuator 52 as shown in the second cross-sectional view. As shown in the third cross-sectional view, first cam surface 90 holds the cap 82 at the first distance for the remainder of the rotation of dual action cam 50.

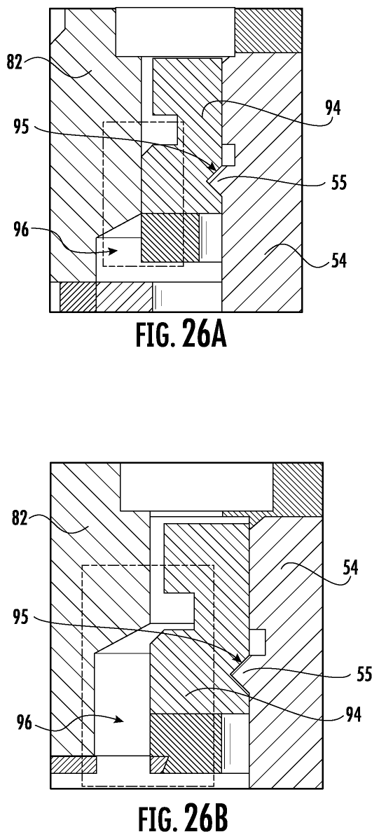

Referring to FIG. 25, cross-sectional views showing reclamping and engagement of the second cam surface 92 are shown according to an exemplary embodiment. Referring to the first cross-sectional view, clamping assembly 26 is being reclamped. During the reclamping, actuator return spring 80 returns clamp actuator 52 to the top position (see, e.g., FIG. 23). With the extension of return spring 80, cap 82 moves allowing ball(s) 84 to recouple or move into the corresponding grooves 78.

As shown in the second cross-sectional view of FIG. 25, second cam surface 92 interfaces against cap 82, applying a force downward (toward cap 82, along axis 44). First and second wings 94 are positioned between a lower surface of clamp actuator 52 and washer 86. With the application of the force, the first and second wings 94 move into respective pockets 96 within cap 82. The movement of the wings 94 into pockets 96 moves wings 94 away from spindle 54 such that the spindle 54 is released and removable from clamping assembly 26. Wings 94 move outward or away from output axis 44.

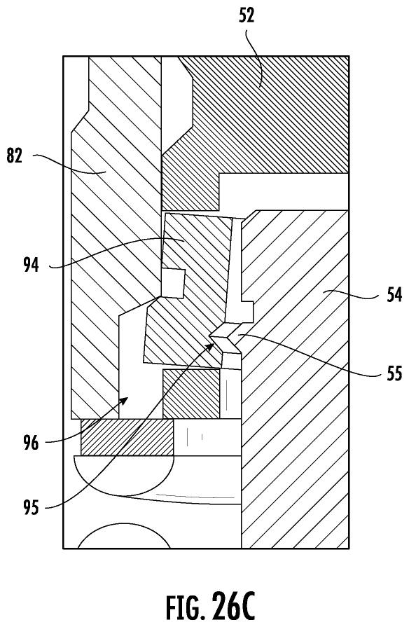

Referring to FIGS. 26A-B, details of the locking and unlocking of clamping assembly 26 are shown according to an exemplary embodiment. As shown in FIG. 26A, clamping assembly 26 is in the locked position. In the locked position, wing 94 is engaged with spindle 54 such that wing 94 resists movement of spindle 54 out of cap 82. In a specific embodiment, spindle 54 includes a projection, shown as a radial projection 55 that engages a groove 95 on wing 94. When the radial projection 55 of the spindle 54 is positioned within the groove 95 of the wing 94, the spindle 54 is secured to the clamping assembly 26.

As shown in FIG. 26B, clamping assembly 26 is moving into the unlocked position. As previously discussed, the downward force applied to cap 82 moves wing 94 downward, along output axis 44 (i.e., toward output element 16) and toward pocket 96. As wing 94 moves down there is additional space to move radially outward once wing 94 reaches pocket 96. When wing 94 is moved outward, wing 94 disengages from spindle 54 and is spaced apart from spindle 54. In other words, there is no longer direct contact between wing 94 and spindle 54. The disengagement from the spindle 54 allows for the removal of spindle 54 from clamping assembly 26. In a specific embodiment, when spindle 54 includes a projection, shown as a radial projection 55, the groove 95 of wing 94 separates from the radial projection 55 in the unlocked position. As shown in FIG. 26C, wing 94 then moves into the space of pocket 96.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A powered multi-tool comprising:
a housing comprising:
a first end; and
a second end opposite the first end;
a head positioned at the first end of the housing;
a motor and a drive mechanism supported at least partially within the housing, the drive mechanism comprising:
an output shaft configured to move in a rotational and oscillating manner and defining an output axis;
a power source positioned at the second end of the housing, the power source configured to supply power to the motor;
an elastic component comprising one or more ribs extending between the motor and the power source; and
a counterweight positioned along an axis defined by the motor between the elastic component and the motor.

2. The powered multi-tool of claim 1, wherein the one or more ribs comprise a first pair of ribs spaced from a second pair of ribs.

3. The powered multi-tool of claim 1, wherein a first end of the one or more ribs is coupled to the counterweight and a second end of the one or more ribs is coupled to one or a controller or power source.

4. The powered multi-tool of claim 1, further comprising a mass damper positioned at a distal end of the output shaft.

5. The powered multi-tool of claim 4, wherein the mass damper comprises a first segment and a second segment that extends further radially outward from the output axis than the first segment.

6. The powered multi-tool of claim 5, further comprising an output accessory removably coupled to the output shaft and configured to be driven by the output shaft, wherein the second segment is oriented opposite to a working end of the output accessory.

7. The powered multi-tool of claim 6, wherein the output accessory is a cutting blade, and wherein the working end of the cutting blade comprises teeth extending in an opposite direction from the second segment of the mass damper.

8. The powered multi-tool of claim 1, wherein the counterweight connects directly to a backplate of motor.

9. The powered multi-tool of claim 5, wherein the counterweight has a weight of about 130 grams.

10. A powered multi-tool comprising:
a housing;
a head positioned at a first end of the housing;
a motor and a drive mechanism supported at least partially within the housing, the drive mechanism comprising:
an output shaft positioned at the head and configured to move in a rotational and oscillating manner, the output shaft defining an output axis;
a power source positioned at least partially within the housing, the power source configured to supply power to the motor;
an elastic component comprising at least one rib extending between the motor and the power source; and
a mass damper supported at a distal end of the output shaft and positioned between the accessory and the housing.

11. The powered multi-tool of claim 10, comprising a counterweight supported within the housing and positioned between the elastic component and the motor.

12. The powered multi-tool of claim 11, wherein the counterweight is coupled to the elastic component and the motor.

13. The powered multi-tool of claim 10, wherein the elastic component is spaced from an interior surface of the housing and coupled to the motor and the power source.

14. The powered multi-tool of claim 10, wherein the mass damper comprises an opening defined between a first segment and a second segment, wherein the second segment extends further radially outward from the output axis than the first segment.

15. The powered multi-tool of claim 10, further comprising a clamping assembly configured to engage the output shaft, the clamping assembly comprising:
a cam configured to engage a cap, the cam comprising:
a first cam surface; and
a second cam surface different than the first cam surface;
a clamp actuator positioned within the cap and configured to engage the output shaft.

16. The powered multi-tool of claim 15, wherein the second cam surface has a greater radial extension than the first cam surface.

17. The powered multi-tool of claim 16, wherein, when the second cam surface engages the cap, a force of the cam on the cap moves the clamping assembly into an unlocked position in which the output shaft is removable from the housing.

18. A powered multi-tool comprising:
a housing;
a head positioned at a first end of the housing;
a motor and a drive mechanism supported at least partially within the housing, the drive mechanism comprising:
an output shaft positioned at the head and configured to move in a rotational and oscillating manner, the output shaft defining an output axis;
a clamping assembly that supports the output shaft at least partially within the housing, the clamping assembly comprising:
a cap;
a cam rotatably engaged with the cap, the cam comprising:
a first cam surface; and
a second cam surface, wherein, when the first cam surface is engaged with the cap the output shaft is securely coupled to the housing, and wherein, when the second cam surface is engaged with the cap the output shaft is removable from the housing;
a power source positioned at least partially within the housing, the power source configured to supply power to the motor;
an elastic component comprising at least one rib extending between the motor and the power source; and
a mass damper supported at a distal end of the output shaft and positioned between the accessory and the housing.

19. The powered multi-tool of claim 18, further comprising a counterweight supported within the housing and positioned between the elastic component and the motor.

20. The powered multi-tool of claim 18, wherein the mass damper comprises:
a first generally arcuate segment that extends a first radial distance from the output axis; and
a second generally arcuate segment that extends a second radial distance from the output axis, wherein the second radial distance is greater than the first radial distance, and wherein the second generally arcuate segment extends in an opposite direction to a working end of the accessory.
